(19) United States
(12) Patent Application Publication
(10) Pub. No.: US 2002/0069542 A1
(43) Pub. Date: Jun. 13, 2002

(54) Kerf indicating system for a cutting device

(76) Inventor: John M. Musacchia JR., Douglasville, GA (US)

Correspondence Address: Rider Bennett Egan & Arundel, 333 South Seventh Street Suite 2000, Minneapolis, MN, 55402, US

(21) Appl. No.: 09/732,803

(22) Filed: Dec. 8, 2000

(51) Int. Cl. G01C 3/12; G01C 1/02

(52) U.S. Cl. 33/286; 33/285

(57) ABSTRACT

A chain saw accessory that enables the operator to quickly and easily cut equal length segments of a log. The accessory includes a discernible marking path source capable of providing a discernible mark on the log in proximity to the cut end of the log, and an adjustment mechanism capable of adjusting the location of the discernible mark on the log.

### BACKGROUND OF THE INVENTION

1. Field of the Invention

The present invention relates to the field of measuring devices, and more particularly to a novel kerf guide attachable to power saws and the like. The guide enables the quick and easy cutting of equal length segments of a work piece, for example, a log being cut by a chain saw. The kerf guide provides a visual mark on the log in proximity to the cut end of the log, which it turn defines the cut site for the chain saw.

2. Description of Related Art

It is frequently desirable to cut logs to a uniform predetermined length, either for use as firewood for fireplaces and woodburning stoves or for sale as pulp wood. Chain saws are widely used to cut logs into lengths. While it is rare that such lengths be measured with great precision, it is desirable that the length of each piece not depart from an intended standard length by more than a reasonable tolerance. For example, a piece that is too long to fit within a stove is undersirable. In addition, persons who purchase firewood in cords or stacks sometimes become suspicious of being cheated if a stack has pieces of numerous different lengths.

In the past, it has been the conventional practice when cutting a work piece, such as a panel of wood, to scribe a line on the surface of the panel. After the operator has provided the cut line, the operator leads the saw along the line during the cut. A ruler, measuring tape, or stick of measured length typically is used to mark off successive lengths to be cut. Yet, the relatively simple act of marking the line often takes as much time as cutting, and thus limits the operator's efficiency as he/she must periodically reach into a pocket to retrieve or to store such a measurement device. Further, the operator must carry such a marking device from sawing location to location without losing it, as these types of measuring aids are not fixed to the cutting device.

It also is known to use various types of fixed measuring rods or wires attached to a chain saw for use as length-measuring means, as disclosed in U.S. Pat. Nos. 4,233,739, 4,299,034 and 4,388,762. Such devices are disadvantageous both because they are easily bent or otherwise damaged, and because they tend to interfere with some chain saw operations. Various elongated rods that mount on a chain saw and protrude therefrom can snag on or strike branches or trees and create danger.

Electrical measuring devices, as opposed to potentially bulky mechanical measuring devices have also been used in the cutting mills. It is known to provide a light-emitting guide to a cutting device in order to provide an illuminated pathway for the cutting device to follow. Examples of these types of devices are disclosed in U.S. Pat. Nos. 4,676,130, 4,885,967, 5,375,495 and 5,675,899. These guides are best used in connection with a flat work piece that requires a lengthy cut, such that a continuous path of light is needed to ensure a straight cut. These devices are disadvantageous when cutting a log, for example, where the lighted pathway can be difficult to find on the log when in front of the chain saw, constantly forcing the operator to adjust the position of the chain saw during cutting to catch a glimpse of the light path. Further, when cutting a log, the light path need only be on the log for a short time in order to provide a guide mark for the beginning of a cut from a chain saw, as opposed to a rotary power saw cutting a flat work piece. These alignment devices are not beneficial when the work piece to be cut is curved or otherwise irregular as opposed to flat, as the path of light upon such a work piece can appear wavy. Further, the path of light may not help at all if the work piece is of a color, or a variety of colors, that makes the path of light too faint to see.

It would be beneficial to provide a compact cutting device guide that eliminates the need for marking the work piece beforehand. It also would be beneficial to provide a lightweight guide that enables quick and repeatable cutting of a work piece by focusing a mark at the cut end of the work piece, thus relieving the cutting device operator from following a mark that is located just in front of the cutting device. The present invention provides a guide incorporating these and other advantageous features.

### SUMMARY OF THE INVENTION

The present invention enables the certain and repeatable measurement of a length of log or other material being cut by a power saw, such that cut sections of the log can be of a predetermined, uniform length. Briefly described, in a preferred form, the present invention is an integral feature of a chain saw that can define the cut path for the chain saw by interrelating three straight lines forming a triangle, and an angle of the triangle. Alternatively, the present device can be a separate accessory for a chain saw. A first line is defined as running parallel to the work piece and is a length of the desired length of the similar segments of the work piece. A second line is defined as running perpendicular to the work piece and is the length between the present accessory device and the work piece. A third line is defined as running between the present accessory device and the cut end of the log. The angle is defined as the angle between the second and third lines.

The orientation and length of the first and second lines are known to the operator. The third line, and thus the angle, are provided by the present accessory device. The present kerf indicating accessory comprises a light source and an adjustment mechanism for the light source. The kerf indicating accessory will be representatively described as used in cooperation with a chain saw and a log to be cut being supported between sawhorses.

Initially, the chain saw is held approximately normal to the log. The chain saw is located some distance from one end (the cut end) of the log, wherein that distance is the length of log desired to be repeatably cut from the log, and which is the first line. The second line runs the distance from the accessory to the log. The operator then aligns the light source on the chain saw such that a beam of light intersects the log in proximity to the end of the log, thus providing a mark of light at the end of the log. This beam of light is the third line. All the while, the chain saw maintains the normal orientation with the log. For example, if the length of log to be cut is five feet (first line), and the light source is two feet from the log when the chain saw is properly aligned (second line), then the light path (third line) will shine at an angle of approximately 68 degrees (the angle) from the chain saw. That angle is then releasably secured, and the log is cut at the five foot mark.

Where the log was just cut now becomes the end of the log upon which the beam should shine once again. When the beam crosses the path of the log at the cut end, if the beam angle remains 68 degrees, the operator knows he/she is five feet from that end, and the log can be recut. As such, the operator need only look to the cut end of the log while maintaining the chain saw in an approximately normal relationship with the log, and when the mark of light from the light source crosses the log in proximity to the cut end, the operator begins the next cut, assured that the segment of log being cut will be nearly identical to the first segment cut.

The present accessory device is capable both of repeatably redefining for the operator the predetermined length of log to be cut, and of providing an indication to the operator when the chain saw is at the proper length along the log to begin cutting. As such, successive cuts of nearly identical lengths of the log rapidly can be made. A superior aspect of the invention is the generation of an alignment mark at the cut end of the log in order to define the proper location of the next cut on the log, which alignment mark is easy to recognize by the operator. This is advantageous over conventional power saw guides that illuminate an alignment mark on the work piece at the path of cutting, not at the end of the log, which path of cutting can be hard to see when directly in front of the cutting device. Although the invention is useful in many cutting environments, it is particularly well suited for chain saws.

The light source can be a passive or an active source. The light source can comprise reflecting surfaces to redirect sunlight to the end of the log, and can include a focusing member to intensify the redirected light. Alternatively, the light source can comprise an active light source, for example, a battery-operated laser pointer.

The adjustment mechanism can include indicia representing the angles at which the light path should shine from the chain saw for a given length of lumber. If the kerf indicating system is associated with a chain saw that maintains the indicating system two feet away from the log, then the adjustment mechanism can include measurement indicia indicating the proper angle of the light path for a given length of cut.

The kerf indicating system can further comprise a switch that can turn the light source on and off.

Thus, an object of the present invention is to provide an improved kerf indicating system.

These and other objects, features, and advantages of the present invention will be more apparent upon reading the following specification in conjunction with the accompanying drawings.

### BRIEF DESCRIPTION OF THE DRAWINGS

FIG. 1 illustrates a perspective view of a preferred environment of the present invention, that being fixed to a chain saw.

FIG. 2 is a top view of FIG. 1 illustrating the geometry utilized by the present invention.

FIG. 3 shows an active light source of the present invention.

FIG. 4 shows a passive light source of the present invention.

FIG. 5 shows an adjustment mechanism of the present invention.

### DETAILED DESCRIPTION OF PREFERRED EMBODIMENTS

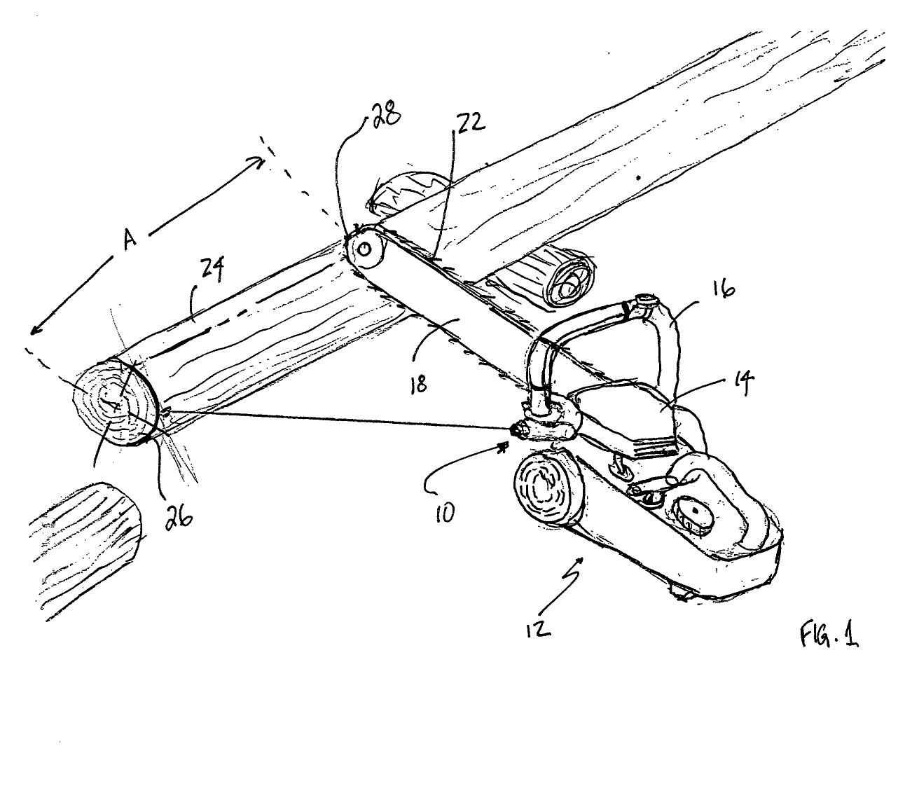

Referring now in detail to the figures, wherein like reference numerals represent like parts throughout the several views, FIG. 1 shows the present kerf indicating system 10 accompanying a chain saw 12 having an engine 14 in an engine housing and a rear handle 16. Extending from the engine housing is a chain bar 18 on which is mounted a cutting chain 22. The cutting chain 22 is drawn about the chain bar 18 by a sprocket (not shown) mounted on the engine 14. Various styles of chain saws 12 are made by different manufacturers, all of which in general fall within the above general description of a chain saw 12.

In a typical cutting motion, the chain bar 18 is first aligned in a perpendicular relationship with the length of the work piece, as shown in FIG. 1 as log 24. The desired length A of log 24 to be cut is defined as the distance between a cut end 26 of the log 24 and the kerf 28 being the cut path of the chain 22 through the log 24. The operator of the chain saw 12 then cuts the log at the kerf 28 in a generally downward cutting motion through the log 24. As the chain bar 18 is fairly rigid, once a cut is begun with the chain saw in a normal plane with the log, the cut will produce an approximately normal cut end to the log. The kerf 28 becomes the next cut end 26 of the log for the subsequent cut. In order to cut yet another piece of the log the length A, the chain saw is moved to the right (as viewed in FIG. 1) of the kerf path 28 (now the cut end 26) the distance A, and another cut is made.

It is known to measure the distance A from the cut end 26 of the log 24 via mechanical attachments extending from the chain saw 12 to the cut end 26, but it is obvious such a measuring system is obtrusive to rapid cutting and is somewhat cumbersome to use. It is also known to shine a path of light at the kerf 28 location in order to provide a light path to follow during cutting, but it is obvious such a light path can be difficult to find on the log due both to color and texture variations of the log, and because the chain bar 18 can interfere with the operator's line of sight to the light path. Additionally, a chain saw need not necessarily follow a path during cutting, because if the cut is begun correctly, a chain saw will produce a proper cut face due to the rigidness of the chain bar 18.

The present invention is provided to enable the rapid and accurate cutting of a log into similarly sized segments without resort to a mechanical extension from the chain saw or a device that provides a cut path of light to follow during cutting. The present invention is a kerf indicating system 10 for a cutting device capable of cutting a length of a work piece at a kerf, preferably a chain saw 12, the work piece having a cut end 26, the kerf indicating system 10 comprising a discernible marking path source 30 and an adjustment mechanism 50.

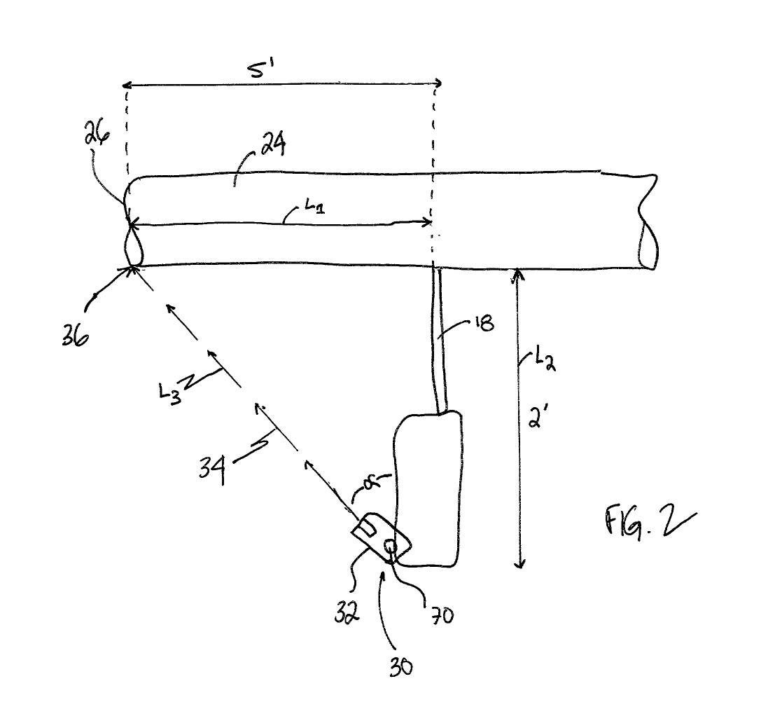

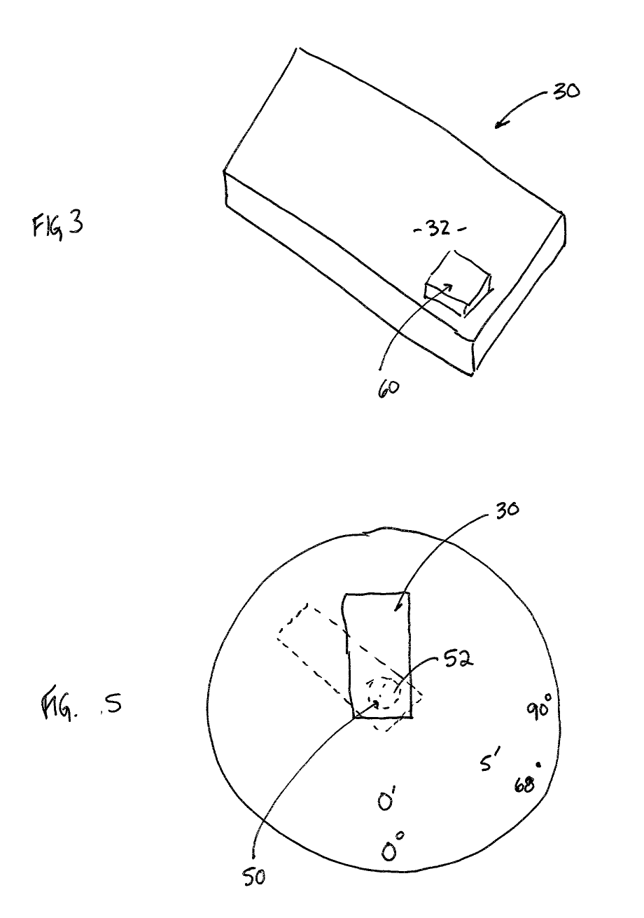

The discernible marking path source 30 is capable of providing a discernable marking path at an angle from the cutting device to the work piece, the discernable marking path source 30 further capable of locating a discernable mark on the work piece in proximity to the cut end 26 of the work piece. In preferred form as illustrated in FIGS. 2 and 3, the discernible marking path source is a laser light source 32. The light source 32 provides a marking path being a beam of light 34 from the light source 32 to the cut end 26 of the work piece 24. A discernible mark 36 is produced at the cut end 26 of the work piece upon intersection of the beam 34 and the work piece 24.

Referring to the geometric relationships of the three straight lines forming a triangle, and an angle of the triangle, the first line L₁, in FIG. 2 runs along the edge of the log from the cut end 36 to the end of the chain bar 18. L₁ is shown above the edge of the log for clarity. The second line L₂ is perpendicular to L₁, and although shown to the right of the chain saw for clarity, would run parallel to the midline of the chain bar 18 from L₁ to the accessory. The third line L₃ is shown in dashed line from the accessory to the cut end 26 of the log 24. The angle α is defined as the angle between L₂ and L₃.

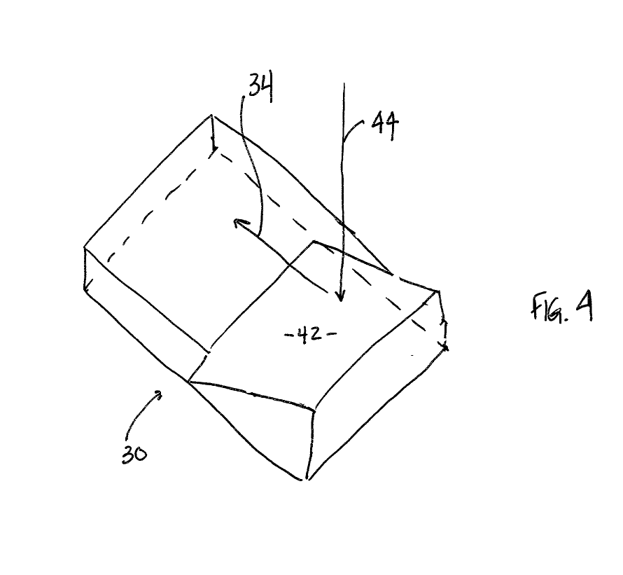

The discernible marking path source 30 alternatively can be a passive device capable of reflecting energy from an energy source at an angle from the cutting device to the work piece, the discernable mark 36 on the work piece being a mark of the reflected energy, as shown in FIG. 4. As such, the path source 30 can comprise one or more reflecting surfaces 42 aligned in such a way so as to reflect overhead light 44 onto the work piece, for example, sunlight if such is available.

The adjustment mechanism 50 is capable of adjusting the angle of the beam of light 34 from the cutting device to the work piece. As shown in FIG. 5, the adjustment mechanism 50 can be a rotatable housing 52 capable of being releasably secured relative to the orientation of the cutting device. If the length of the cutting element used in conjunction with the present invention 10 is known, for example, the length of the chain bar 18, then the adjustment mechanism 50 can include discrete setting indications relating to the desired length of cut, as illustrated in FIG. 5, as shown as the 0 and 5 feet indications.

As shown in FIG. 5, the adjustment mechanism 50 can alternatively include discrete angle indications, as shown as the 0° angle and 68° angle indications. Returning to FIG. 2, if it is known that the path source 30 is located at a point two feet away from the log 24, and it is known that the length of desired cut is in five feet increments, angle a will equal 68 degrees in order to shine the beam of light 34 to the cut end 26 of the log 24 to place the discernible mark 36 in proximity to the cut end 26.

If the consumer of the present invention 10 intends to use the path source 30 on various cutting devices, all of which have a different length from the work piece to the path source location (for example, L₂ in FIG. 2), then the operator would typically use the angle indications on the adjustment mechanism 50.

The present kerf indicating system 10 further can comprise a sound source 60 as shown in FIG. 3 capable of making an audible sound when the beam of energy is in close proximity to the cut end of the work piece. The sound source can be used in connection with a marking path source 30 being a radar source, for example, that does not provide a visual mark 36 on the log, but works in tandem with the sound source 60 to indicate when the radar source is in proximity to the cut end 26 of the work piece.

It is preferably that the path source 30, the adjustment mechanism 50 and the sound source 60 be fixed to the cutting device, but such need not be the case.

The present kerf indicating system 10 further can comprise a mark removing device 70 for selectively removing the discernable mark from the work piece. The mark removing device 70 can be an on/off switch 70 (shown in FIG. 2), and is especially useful when used in connection with an active path source 30, wherein the path source 30 can be turned on and off, saving power consumption. Alternatively, the mark removing device 70 and can be a slide (not shown) or other mechanical blocking means to intersect a beam of reflected light either before or after it is reflected toward the end of the work piece.

A method of repeatable cutting similar lengths of a work piece having a cut end is also disclosed. First, the cutting device is located at a desired distance from the cut end of the work piece. The path source 30 then is adjusted by the adjustment mechanism 50 so as to mark the cut end of the work piece. The operator then releasably secures the adjustment mechanism 50 to secure the angle of the path. The work piece then is cut, and that location becomes the new cut end 26 of the work piece.

While the invention has been disclosed in its preferred forms, it will be apparent to those skilled in the art that many modifications, additions, and deletions can be made therein without departing from the spirit and scope of the invention and its equivalents as set forth in the following claims.

what is claimed is:

1. A kerf indicating system comprising:
(a) a cutting device capable of cutting a length of a work piece at a kerf, the work piece having a cut end;
(b) a discernible marking path source capable of providing a discernible mark on the work piece in proximity to the cut end of the work piece; and
(c) an adjustment mechanism capable of adjusting the location of the discernible mark on the work piece.

2. The kerf indicating system of claim 1, the discernable marking path source being a passive device capable of reflecting energy from an energy source at an angle from the cutting device to the work piece, the discernable mark on the work piece being a mark of the reflected energy.

3. The kerf indicating system of claim 1, the discernable marking path source being an active device capable of providing a beam of energy at an angle from the cutting device to the work piece, the discernable mark on the work piece being a mark of the beam of energy

4. The kerf indicating system of claim 2, the energy source being a source of visible light.

5. The kerf indicating system of claim 3, the beam of energy being a beam of visible light.

6. The kerf indicating system of claim 3, further comprising a sound source capable of making an audible sound when the beam of energy is in close proximity to the cut end of the work piece.

7. The kerf indicating system of claim 1, the discernable marking path source being fixed to the cutting device.

8. The kerf indicating system of claim 1, the adjustment mechanism being fixed to the cutting device.

9. The kerf indicating system of claim 1 further comprising a mark removing device for selectively removing the discernable mark from the work piece.

10. The kerf indicating system of claim 3 further comprising a mark removing device for selectively removing the discernable mark from the work piece, the mark removing device being a switch to turn on and off the beam of energy.

11. A kerf indicating system for a cutting device capable of cutting a length of a work piece at a kerf, the work piece having a cut end, the kerf indicating system comprising:
(a) a light source capable of providing a light path at an angle from the cutting device to the work piece, the light source further capable of locating a mark of light on the work piece in proximity to the cut end of the work piece; and
(b) an adjustment mechanism capable of adjusting the angle of the light path from the cutting device to the work piece.

12. The kerf indicating system of claim 11, the cutting device being a chain saw and the light source being a passive device capable of reflecting sunlight at an angle from the chain saw to the work piece.

13. The kerf indicating system of claim 11, the cutting device being a chain saw and the light source being source being an active device capable of providing a laser beam at an angle from the chain saw to the work piece.

14. The kerf indicating system of claim 13, the light source being fixed to the chain saw.

15. The kerf indicating system of claim 14 further comprising a switch for selectively turning on and off the laser beam.

16. A method of repeatably cutting similar lengths of a work piece, the work piece having a cut end, the method comprising the following steps:
(a) providing a cutting device at a desired distance from the cut end of the work piece, the cutting device capable of cutting through the work piece;
(b) marking with a discernable mark the cut end of the work piece, the discernable mark formed by the intersection of a discernable marking path with the work piece, the discernable marking path at an angle from the cutting device to the cut end of the work piece;
(c) fixing the angle of the discernable marking path from the cutting device;
(d) cutting the work piece at a kerf with the cutting device at the desired distance from the cut end of the work piece, the kerf becoming the cut end of the cut end of the work piece;
(e) repeating steps (b)-(d) until the number of desired lengths of the work piece have been cut.

17. The method of repeatable cutting similar lengths of a work piece according to claim 16, the discernable marking path being a path of reflected light from a light source, the discernable mark on the work piece being a mark of light.

18. The method of repeatable cutting similar lengths of a work piece according to claim 16, the discernable marking path being a path of generated light from a light source, the discernable mark on the work piece being a mark of light.

19. The method of repeatable cutting similar lengths of a work piece according to claim 18, the light source being fixed to the cutting device.

20. A method of repeatable cutting similar lengths of a work piece, the work piece having a cut end, the method comprising the following steps:
(a) providing a chain saw at a desired distance from the cut end of the work piece, the chain saw capable of cutting through the work piece;
(b) marking with a beam of light the cut end of the work piece, the beam of light at an angle from the chain saw to the work piece;
(c) fixing the angle of the beam of light from the chain saw to the cut end of the work piece;
(d) cutting the work piece at a kerf with the chain saw at the desired distance from the cut end of the work piece, the kerf becoming the cut end of the work piece;
(e) repeating steps (b)-(d) until the number of desired lengths of the work piece have been cut.

21. The method of repeatable cutting similar lengths of a work piece according to claim 20, the beam of light being a beam of reflected light from a light source.

22. The method of repeatable cutting similar lengths of a work piece according to claim 20, the beam of light being a beam of generated light from a laser light source.

23. The method of repeatable cutting similar lengths of a work piece according to claim 22, the laser light source being fixed to the chain saw.
